(19) United States
(12) Patent Application Publication
(10) Pub. No.: US 2025/0202940 A1
(43) Pub. Date: Jun. 19, 2025

(54) CLOUD FIREWALL CONFIGURATION MANAGEMENT USING GRAPH DATA MODEL

(71) Applicant: Palo Alto Networks, Inc., Santa Clara, CA (US)

(72) Inventors: Sathyanarayana Bhat, Sunnyvale, CA (US); Arpita Chattopadhyay, Saratoga, CA (US); Sandeep Reddy Panuganti, Union City, CA (US); Karthik Krishnan Ramasubramanian, Newark, CA (US); Harish Kumar Shankar, San Francisco, CA (US)

(21) Appl. No.: 18/539,059

(22) Filed: Dec. 13, 2023

(51) Int. Cl. H04L 9/40

(52) U.S. Cl. CPC H04L 63/20; H04L 63/0227; H04L 63/1433

(57) ABSTRACT

A system, method, and device for representing a firewall configuration is disclosed. The method includes (i) generating a graph model using a model generator for a security policy configuration that includes a plurality of network parameters; and (ii) processing a query and generating a response using the graph model.

### BACKGROUND OF THE INVENTION

As the digital landscape continues to evolve, ensuring the security of networks becomes increasingly paramount. Firewalls serve as a crucial component in safeguarding network infrastructures by controlling and monitoring the flow of data between trusted and untrusted networks. However, the configuration of firewall security policies can become intricate and challenging to manage as networks expand and diversify.

Existing approaches often rely on rule-based representations, making it difficult for administrators to grasp the overall structure and dependencies of the security policy. Consequently, there is a growing need for a more intuitive and comprehensive representation that enables administrators to visualize, analyze, and modify firewall configurations with greater efficiency.

### BRIEF DESCRIPTION OF THE DRAWINGS

Various embodiments of the invention are disclosed in the following detailed description and the accompanying drawings.

FIG. 1 is a block diagram of an environment for providing security to a network according to various embodiments.

FIG. 2 is a block diagram of system for maintaining a graph database associated with a graph model for a security policy configuration of a network according to various embodiments.

FIG. 3 is a block diagram of system for maintaining a graph database associated with a graph model for a security policy configuration of a network according to various embodiments.

FIGS. 4A and 4B show an example of a graph model for a security policy configuration that includes a plurality of network parameters according to various embodiments.

FIGS. 5A-5D show an example of a graph model according to various embodiments.

FIGS. 6A and 6B show an example of a graph model query to determine whether a security object is visible for a specific firewall device according to various embodiments.

FIG. 7 is a flow diagram of a method for analyzing a security policy configuration for a network according to various embodiments.

FIG. 8 is a flow diagram of a method for querying a graph model pertaining to a security policy configuration for a network according to various embodiments.

FIG. 9 is a flow diagram of a method for querying a graph model pertaining to a security policy configuration for a network according to various embodiments.

FIG. 10 is a flow diagram of a method for predicting a security posture of a network based at least in part on a graph model for a security policy configuration according to various embodiments.

FIG. 11 is a flow diagram of a method for training a model according to various embodiments.

FIG. 12 is a user interface for querying a graph model according to various embodiments.

FIG. 13 is a user interface for querying a graph model according to various embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

Security vendors encounter challenges to configure and manage a large number of devices or assets (e.g., firewalls or other types of devices) for customers (e.g., organizations associated with an enterprise network). Each configuration (e.g., a security policy configuration that may comprise a plurality of firewall rules, etc.) comprise a large number of complex and interconnected objects that may be organized in a nested or hierarchical folders. Managing these objects and providing an analysis or assessment with respect to the security policy configuration is challenging. For example, related art systems cannot easily respond to a query such as “does the security policy configuration protect the enterprise network against a set of identified threats?”.

Related art systems manage physical or virtual firewall devices and apply policies to the firewall devices. Such systems manage configurations for the firewall devices by using a relational key-value, JSON, XML, etc. In related art systems, translating a security policy configuration from a relational model to a data model is difficult and is prone to a lot of bus or inconsistencies. Further, translation of models in related art systems is complex and computationally intensive.

Various embodiments generate a graph model that represents the security policy configuration of a firewall system. The graph model encapsulates the relationships and dependencies between various firewall rules, providing a visual representation that simplifies the understanding of complex security policies. The graph model may be stored in a graph database that can be queried in connection with analyzing the security posture of an enterprise network or to analyze the interdependencies or relationships among nodes (e.g., network devices). This graph-based approach enhances the ability of administrators to manage and optimize firewall configurations by offering a clear and concise visualization of the network security landscape.

In some embodiments, the system generates a graph model based on a security policy configuration. The graph model may comprise a plurality of nodes (e.g., data objects) and interconnections (e.g., edges such as directed edges). Nodes in the graph can correspond to a specific firewall rule or a group of related rules, encapsulating information such as source and destination addresses, protocols, and actions. Directed edges between nodes signify the order of rule evaluation and the flow of traffic between different policy components, offering a visual depiction of the policy execution sequence. The labelling of the edges allows the system to categorize data objects or relationships, and/or to determine how a set of data objects are related to one another. The graph model can capture a hierarchy of objects, how the objects inherit certain properties, mask behavior properties, and/or shadow behavior properties.

In some embodiments, the system identifies each relationship among data objects within the graph model. For example, the graph model can be used to discern relationships between data objects and to determine how data objects are interconnected. Two data objects (e.g., nodes in the graph model) can be determined to be related based on an interconnectedness (e.g., either direct or indirect) of the data objects. According to various embodiments, the graph model is dynamically updated to reflect real-time changes in the firewall configuration, providing administrators with an up-to-date representation of the security policies.

Various embodiments provide analytics tools (e.g., processes or services) to perform graph-based analyses. The system enables administrators to identify potential vulnerabilities, analyze the impact of rule modifications, and optimize the overall security posture. For example, the system generates a graph model for a security policy configuration and stores the graph model in a manner (e.g., in a graph database) that can be queried.

Various embodiments provide a system, method, and device for representing a firewall configuration. The method includes (i) generating a graph model using a model generator for a security policy configuration that includes a plurality of network parameters; and (ii) processing a query and generating a response using the graph model.

Various embodiments implement a predefined security policy object configuration schema description. The system combines the schema description with a graph model that dynamically represents the policy object structure (e.g., a firewall rule) and its relationship to a hierarchy of network devices/assets or applications or services exposed to the enterprise network. The system can comprise a schema generator and a graph database to persist the graph model. The graph model can be used to perform various operations, queries, and generative functions. The graph database is ACID compliant. For example, querying the graph database returns consistent responses for queries. Additionally, the graph model and/or graph database is stateless, and the data can be used by various services. In contrast, related art systems require taking a snapshot of the model, which requires a large memory footprint.

The system causes the user or system defining a security policy to include a particular specification, such as a port specification, a group of applications specification, an object type specification, a set of objects specification, etc. The system may obtain a set of network or organization requirements and use a graph model for the security policy configuration to determine whether the security policy configuration satisfies the requirements, how the security policy configuration fails to satisfy the requirements, and/or a recommendation for resolving the conflict between the security policy configuration and the requirements.

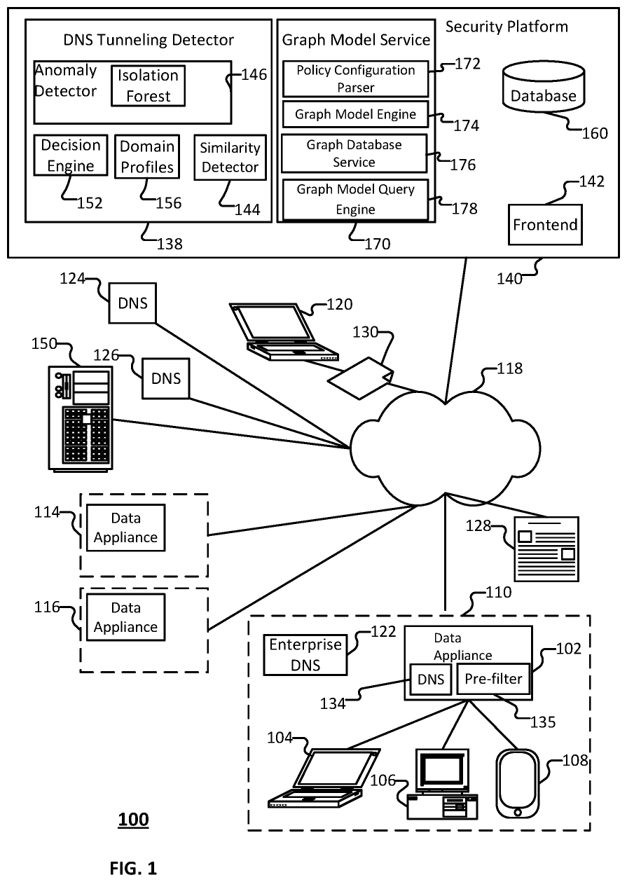

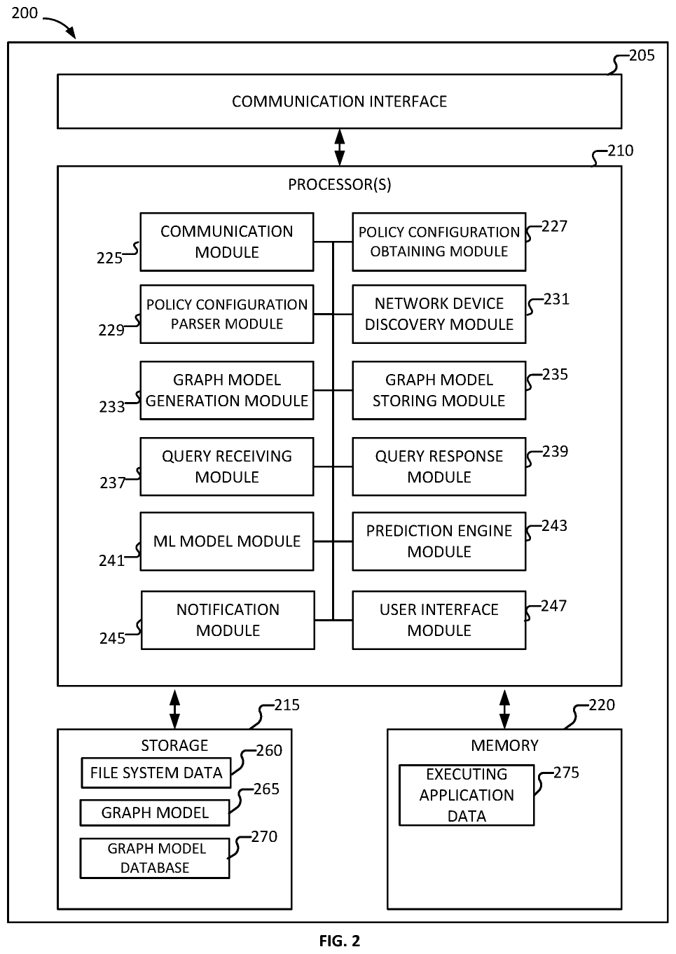

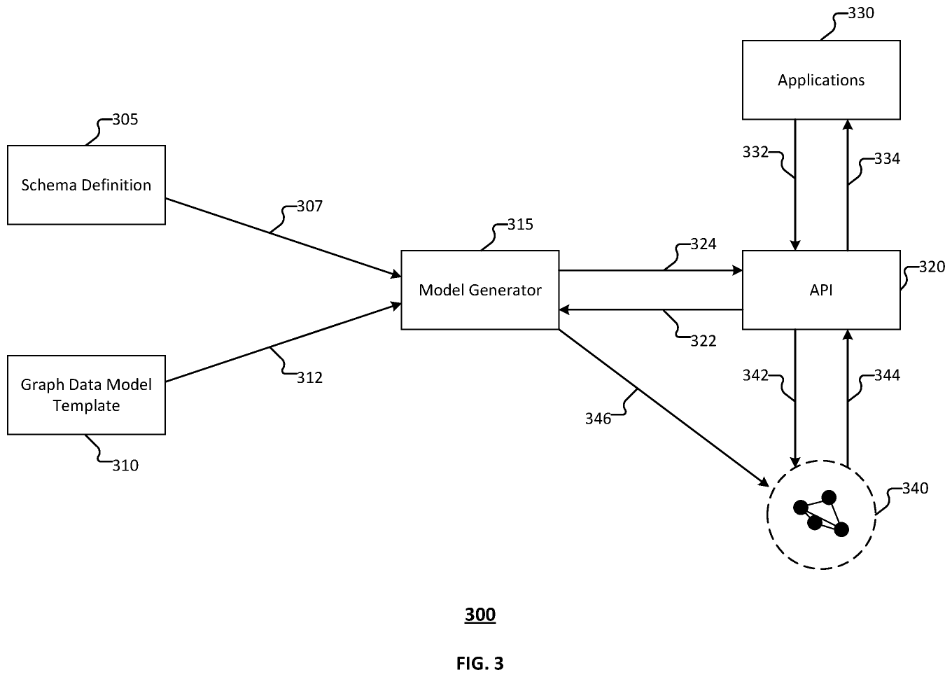

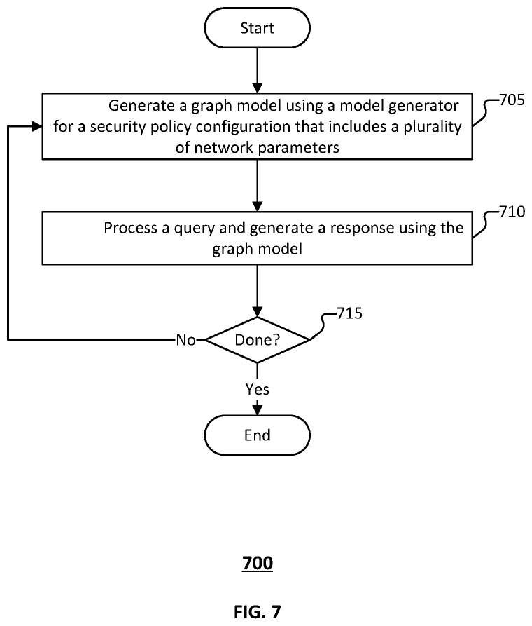

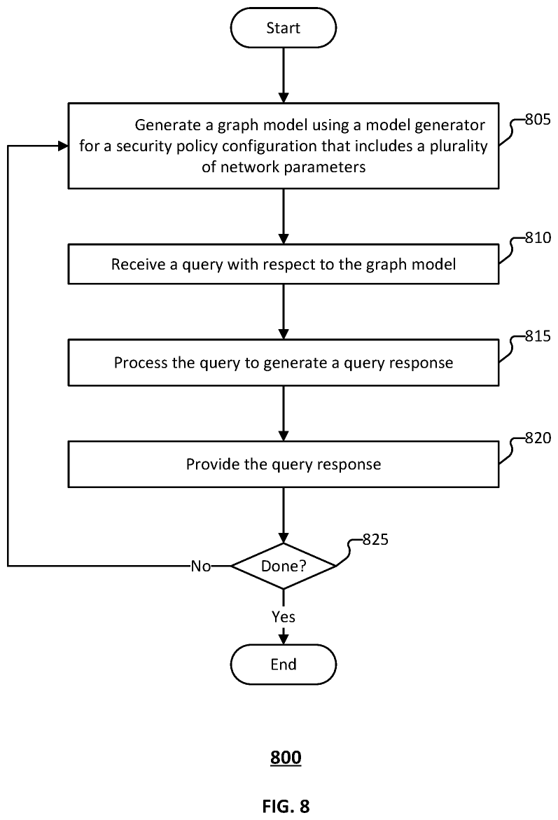

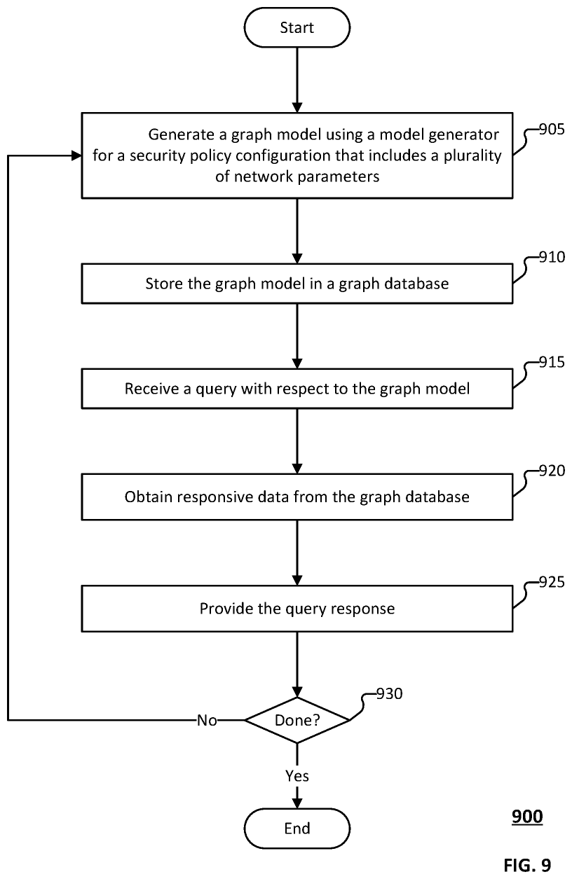

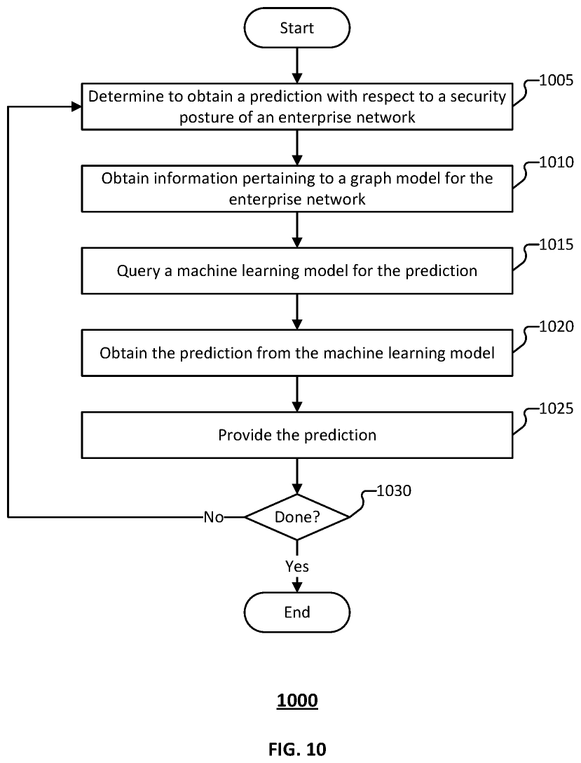

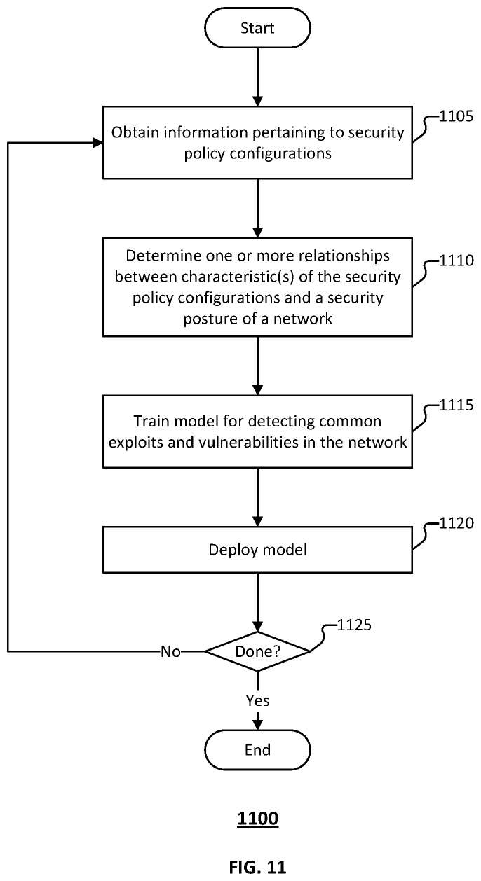

FIG. 1 is a block diagram of an environment for providing security to a network according to various embodiments. In various embodiments, system 100 is implemented in connection with system 200 FIG. 2 and/or system 300 of FIG. 3. In various embodiments, system 100 is implemented in connection with process 700 of FIG. 7, process 800 of FIG. 8, process 900 of FIG. 9, process 1000 of FIG. 10, and/or process 1100 of FIG. 11.

In the example shown, client devices 104-108 are a laptop computer, a desktop computer, and a tablet (respectively) present in an enterprise network 110 (belonging to the “Acme Company”). Data appliance 102 is configured to enforce policies (e.g., a security policy, a network traffic handling policy, etc.) regarding communications between client devices, such as client devices 104 and 106, and nodes outside of enterprise network 110 (e.g., reachable via external network 118). Examples of such policies include policies governing traffic shaping, quality of service, and routing of traffic. Other examples of policies include security policies such as ones requiring the scanning for threats in incoming (and/or outgoing) email attachments, website content, inputs to application portals (e.g., web interfaces), files exchanged through instant messaging programs, and/or other file transfers. Other examples of policies include security policies (or other traffic monitoring policies) that selectively block traffic, such as traffic to malicious domains or parked domains, or such as traffic for certain applications (e.g., SaaS applications). In some embodiments, data appliance 102 is also configured to enforce policies with respect to traffic that stays within (or from coming into) enterprise network 110.

Techniques described herein can be used in conjunction with a variety of platforms (e.g., desktops, mobile devices, gaming platforms, embedded systems, etc.) and/or a variety of types of applications (e.g., Android.apk files, iOS applications, Windows PE files, Adobe Acrobat PDF files, Microsoft Windows PE installers, etc.). In the example environment shown in FIG. 1, client devices 104-108 are a laptop computer, a desktop computer, and a tablet (respectively) present in an enterprise network 110. Client device 120 is a laptop computer present outside of enterprise network 110.

Data appliance 102 can be configured to work in cooperation with remote security platform 140. Security platform 140 can provide a variety of services, including (i) managing/maintaining a security policy configuration(s) for enterprise network 110 and/or devices connected to enterprise network 110 (e.g., managed devices, security entities, etc.), (ii) enforcing the security policy configuration or causing a security entity (e.g., a firewall) to enforce the security policy configuration, (iii) representing the security policy configuration(s) as a graph model(s), (iv) storing the graph model in a graph database, (v) responding to queries with respect to the graph model or graph database, (vi) training a machine learning (ML) model to generate predictions with respect to the graph model or graph database, (vii) generating predictions with respect to the graph model or graph database, such as based on querying the ML model, and/or (viii) performing an active measure with respect to network traffic or files communicated across the network based on an instruction from another service or system or based on security platform 140 using the ML model to generate a prediction with respect to the graph model or graph database (e.g., a prediction of network devices/assets that are vulnerable to a particular threat).

Security platform 140 may implement other services, such as determining an attribution of network traffic to a particular DNS tunneling campaign or tool, indexing features or other DNS-activity information with respect to particular campaigns or tools (or as unknown), classifying network traffic (e.g., identifying application(s) to which particular samples of network traffic corresponding, determining whether traffic is malicious, detecting malicious traffic, detecting C2 traffic, etc.), providing a mapping of signatures to certain traffic (e.g., a type of C2 traffic,) or a mapping of signatures to applications/application identifiers (e.g., network traffic signatures to application identifiers), providing a mapping of IP addresses to certain traffic (e.g., traffic to/from a client device for which C2 traffic has been detected, or for which security platform 140 identifies as being benign), performing static and dynamic analysis on malware samples, assessing maliciousness of domains, determining whether domains are parked domains, providing a list of signatures of known exploits (e.g., malicious input strings, malicious files, malicious domains, etc.) to data appliances, such as data appliance 102 as part of a subscription, detecting exploits such as malicious input strings, malicious files, or malicious domains (e.g., an on-demand detection, or periodical-based updates to a mapping of domains to indications of whether the domains are malicious or benign), providing a likelihood that a domain is malicious (e.g., a parked domain) or benign (e.g., an unparked domain), providing/updating a whitelist of input strings, files, or domains deemed to be benign, providing/updating input strings, files, or domains deemed to be malicious, identifying malicious input strings, detecting malicious input strings, detecting malicious files, predicting whether input strings, files, or domains are malicious, and providing an indication that an input string, file, or domain is malicious (or benign).

In some embodiments, graph model service 170 stores the graph model in database 160, such as in a graph database stored at database 160. Graph model service 170 may store other information pertaining to the graph model to database 160. Additionally, or alternatively, system 100 stores in database 160 results of analysis (and additional information pertaining to applications, domains, etc.), such as an analysis or classification performed by security platform 140. For example, database 160 stores an index of labeled data, such as a mapping of computed features based on DNS-activity information to corresponding DNS tunneling campaigns/tools.

In various embodiments, security platform 140 comprises one or more dedicated commercially available hardware servers (e.g., having multi-core processor(s), 32G+ of RAM, gigabit network interface adaptor(s), and hard drive(s)) running typical server-class operating systems (e.g., Linux). Security platform 140 can be implemented across a scalable infrastructure comprising multiple such servers, solid state drives, and/or other applicable high-performance hardware. Security platform 140 can comprise several distributed components, including components provided by one or more third parties. For example, portions or all of security platform 140 can be implemented using the Amazon Elastic Compute Cloud (EC2) and/or Amazon Simple Storage Service (S3). Further, as with data appliance 102, whenever security platform 140 is referred to as performing a task, such as storing data or processing data, it is to be understood that a sub-component or multiple sub-components of security platform 140 (whether individually or in cooperation with third party components) may cooperate to perform that task. As one example, security platform 140 can optionally perform static/dynamic analysis in cooperation with one or more virtual machine (VM) servers. An example of a virtual machine server is a physical machine comprising commercially available server-class hardware (e.g., a multi-core processor, 32+ Gigabytes of RAM, and one or more Gigabit network interface adapters) that runs commercially available virtualization software, such as VMware ESXi, Citrix XenServer, or Microsoft Hyper-V. In some embodiments, the virtual machine server is omitted. Further, a virtual machine server may be under the control of the same entity that administers security platform 140 but may also be provided by a third party. As one example, the virtual machine server can rely on EC2, with the remainder portions of security platform 140 provided by dedicated hardware owned by and under the control of the operator of security platform 140.

In some embodiments, graph model service 170 maintains/manages one or more security policy configurations. In the example shown, graph model service 170 comprises policy configuration parser 172, graph model engine 174, graph database service 176, and/or graph model query engine 178. Graph model service 170 can receive (e.g., from an administrator or other service or system) new security policy configurations and/or updates to the security policy configurations, such as new or updated firewall rules. Graph model service 170 can represent the one or more security policy configurations as a graph model. The graph model identifies various nodes in a network (e.g., security entities, network devices/assets, or collection of network devices/assets, etc.), a firewall rule, and various applications or services exposed to the firewall rules. Additionally, the graph model can identify/represent relationships among the various nodes in a network, a firewall rule, and various applications or services exposed to the firewall rules. According to various embodiments, graph model service 170 represents each node in the graph as a data object. The data object is defined according to a predefined schema, such as based on a predefined set of attributes that are populated for the node.

Graph model service 170 can use policy configuration parser 172 to parse a security policy configuration being managed/maintained by graph model service 170. Policy configuration parser 172 can analyze the one or more security policy configuration to determine one or more rules (e.g., firewall rules) in the security policy configuration, a set of network devices or a set of network traffic types (e.g., traffic from a particular domain(s), traffic for a particular application or service, etc.) that is subject to the rule, and/or a set of actions or active measures to be performed with respect to the set of network devices and/or the set of network traffic types.

Graph model service 170 can use graph model engine 174 to determine (e.g., generate) a graph model for a security policy configuration. For example, in response to obtaining a parsing of the security policy configuration (e.g., from policy configuration parser 172), graph model engine 174 generates the corresponding graph model(s). In some embodiments, a graph model can be generated for each rule comprised in the security policy configuration.

Graph model service 170 can use graph database service 176 to store a graph model in a graph database. For example, graph database service 176 converts the graph model to a graph database, which can be stored in database 160.

Graph model service 170 can use graph model query engine 178 to respond to queries with respect to the graph model, such as queries received via other applications, services, or systems. In some embodiments, graph model query engine 178 determines a response to a query based on querying the graph database. Additionally, or alternatively, graph model query engine 178 determines the response based on querying a machine learning model that is trained to make predictions with respect to security policy configurations (e.g., to determine predictions based on the graph models corresponding to the security policy configurations). For example, the machine learning model can predict a security posture of a network, network device/asset, or security entity with respect to a particular threat (e.g., a newly identified 0-day exploit, etc.).

Examples of queries that may be received and processed by graph model query engine 178 include: (i) a query to detect whether an object/network device is visible in a firewall device policy, (ii) a query to determine a relationship between two different nodes or network devices in the graph model, (iii) a query to detect whether a particular node is vulnerable to an identified exploit, (iv) a query to determine whether a node is exposed to particular traffic or a particular application (v) a query to determine the nodes associated with a particular IP address, and/or (vi) a query to determine whether a firewall protects against a particular exploit, etc.

According to various embodiments, security platform 140 comprises DNS tunneling detector 138 and/or graph mode service 170. Security platform 140 may include various other services/modules, such as a malicious sample detector, a parked domain detector, an application classifier or other traffic classifier, etc. In response to receiving an indication that an assessment of a sample of network traffic (e.g., C2 type classification, determine whether the malicious/benign, etc.) is to be performed, security platform 140 analyzes the sample to determine the assessment of the network traffic (e.g., C2 traffic classification, determine whether the sample is malicious or benign/non-malicious, etc.) and/or an attribution of the network traffic (e.g., detection that the network traffic corresponds to a particular DNS tunneling campaign or tool).

In some embodiments, system 100 (e.g., a network traffic classifier for security platform 140, an inline firewall or other inline security entity, etc.) determines whether information pertaining to a particular sample (e.g., a newly received sample to be analyzed) is comprised in a dataset of historical samples (e.g., historical network traffic), whether a particular signature is associated with malicious traffic, whether the signature can be attributed to a particular DNS tunneling campaign or tool, or whether traffic corresponding to the sample to be otherwise handled in a manner different than the normal traffic handling. The historical information may be provided by a third-party service such as VirusTotal™. In response to determining that information pertaining to a sample is not comprised in, or available in, the dataset of historical samples, system 100 (e.g., security platform 140 or other inline security entity) may deem that the sample/traffic has not yet been analyzed and system 100 can invoke an analysis (e.g., a sample analysis) of the sample in connection with determining (e.g., predicting) the traffic classification (e.g., an inline security entity can query a classifier, that uses the header information for the sample to query a machine learning model). The historical information (e.g., from a third-party service, a community-based score, etc.) indicates whether other vendors or cyber security organizations deem the particular traffic as malicious or should be handled in a certain manner.

Returning to FIG. 1, suppose that a malicious individual (using client device 120) has created malware or malicious sample 130, such as a file, an input string, etc. The malicious individual hopes that a client device, such as client device 104, will execute a copy of malware or other exploit (e.g., malware or malicious sample 130), compromising the client device, and causing the client device to become a bot in a botnet. The compromised client device can then be instructed to perform tasks (e.g., cryptocurrency mining, or participating in denial-of-service attacks) and/or to report information to an external entity (e.g., associated with such tasks, exfiltrate sensitive corporate data, etc.), such as C2 server 150, as well as to receive instructions from C2 server 150, as applicable.

The environment shown in FIG. 1 includes three Domain Name System (DNS) servers (122-126). As shown, DNS server 122 is under the control of ACME (for use by computing assets located within enterprise network 110), while DNS server 124 is publicly accessible (and can also be used by computing assets located within network 110 as well as other devices, such as those located within other networks (e.g., networks 114 and 116)). DNS server 126 is publicly accessible but under the control of the malicious operator of C2 server 150. Enterprise DNS server 122 is configured to resolve enterprise domain names into IP addresses, and is further configured to communicate with one or more external DNS servers (e.g., DNS servers 124 and 126) to resolve domain names as applicable.

As mentioned above, in order to connect to a legitimate domain (e.g., www.example.com depicted as website 128), a client device, such as client device 104 will need to resolve the domain to a corresponding Internet Protocol (IP) address. One way such resolution can occur is for client device 104 to forward the request to DNS server 122 and/or 124 to resolve the domain. In response to receiving a valid IP address for the requested domain name, client device 104 can connect to website 128 using the IP address. Similarly, in order to connect to malicious C2 server 150, client device 104 will need to resolve the domain, “kj32hkjqfeuo32ylhkjshdflu23.badsite.com,” to a corresponding Internet Protocol (IP) address. In this example, malicious DNS server 126 is authoritative for *.badsite.com and client device 104's request will be forwarded (for example) to DNS server 126 to resolve, ultimately allowing C2 server 150 to receive data from client device 104.

Data appliance 102 is configured to enforce policies regarding communications between client devices, such as client devices 104 and 106, and nodes outside of enterprise network 110 (e.g., reachable via external network 118). Examples of such policies include ones governing traffic shaping, quality of service, and routing of traffic. Other examples of policies include security policies such as ones requiring the scanning for threats in incoming (and/or outgoing) email attachments, website content, information input to a web interface such as a login screen, files exchanged through instant messaging programs, and/or other file transfers, and/or quarantining or deleting files or other exploits identified as being malicious (or likely malicious). In some embodiments, data appliance 102 is also configured to enforce policies with respect to traffic that stays within enterprise network 110. In some embodiments, a security policy includes an indication that network traffic (e.g., all network traffic, a particular type of network traffic, etc.) is to be classified/scanned by a classifier that implements a pre-filter model, such as in connection with detecting malicious or suspicious samples, detecting parked domains, or otherwise determining that certain detected network traffic is to be further analyzed (e.g., using a finer detection model).

In various embodiments, when a client device (e.g., client device 104) attempts to resolve an SQL statement or SQL command, or other command injection string, data appliance 102 uses the corresponding sample (e.g., an input string) as a query to security platform 140. This query can be performed concurrently with the resolution of the SQL statement, SQL command, or other command injection string. As one example, data appliance 102 can send a query (e.g., in the JSON format) to a frontend 142 of security platform 140 via a REST API. Using processing described in more detail below, security platform 140 will determine whether the queried SQL statement, SQL command, or other command injection string indicates an exploit attempt and provide a result back to data appliance 102 (e.g., “malicious exploit” or “benign traffic”).

In various embodiments, when a client device (e.g., client device 104) attempts to open a file or input string that was received, such as via an attachment to an email, instant message, or otherwise exchanged via a network, or when a client device receives such a file or input string, DNS module 134 uses the file or input string (or a computed hash or signature, or other unique identifier, etc.) as a query to security platform 140. In other implementations, an inline security entity queries a mapping of hashes/signatures to traffic classifications (e.g., indications that the traffic is C2 traffic, indications that the traffic is malicious traffic, indications that the traffic is benign/non-malicious, etc.). This query can be performed contemporaneously with receipt of the file or input string, or in response to a request from a user to scan the file. As one example, data appliance 102 can send a query (e.g., in the JSON format) to a frontend 142 of security platform 140 via a REST API. Using processing described in more detail below, security platform 140 will determine (e.g., using a malicious file detector that may use a machine learning model to detect/predict whether the file is malicious) whether the queried file is a malicious file (or likely to be a malicious file) and provide a result back to data appliance 102 (e.g., “malicious file” or “benign file”).

FIG. 2 is a block diagram of system for maintaining a graph database associated with a graph model for a security policy configuration of a network according to various embodiments. According to various embodiments, system 200 is implemented in connection with system 300 of FIG. 3 and/or system 100 of FIG. 1 such as for graph model service 170. System 200 may implement at least part of system 300 of FIG. 3. In various embodiments, system 200 is implemented in connection with process 700 of FIG. 7, process 800 of FIG. 8, process 900 of FIG. 9, process 1000 of FIG. 10, and/or process 1100 of FIG. 11. System 200 may be implemented in one or more servers, a security entity such as a firewall, an endpoint, a security service provided as a software as a service.

System 200 can be implemented by one or more devices such as servers. System 200 can be implemented at various locations on a network. In some embodiments, system 200 implements graph model service 170 of system 100 of FIG. 1. As an example, system 200 is deployed as a service, such as a web service (e.g., system 200 manages security policy configuration, enables a network administrator to configure/define the security policy configuration or a set of firewall rules, analyzes the security policy configuration or the security posture for a firewall or other security entity, predicts whether a network or a particular device is protected against a new threat, train a machine learning model to predict a security characteristic associated with the security policy configuration, such as whether a particular device/service is exposed to an application or vulnerable to a particular threat, etc.). The service may be provided by one or more servers. For example, system 200 or graph model service 170 is deployed on a remote server that monitors or receives network traffic that is transmitted within or into/out of a network and enforces security policies, classifies network traffic (e.g., as malicious, benign, etc.), sends/pushes out notifications or updates pertaining to the network traffic such as an indication of the application to which the network traffic corresponds or an indication of whether an application is malicious, or enables a user or other system to configure the security policy configuration for a network or a particular security entity (e.g., a firewall). In some embodiments, part of system 200 is implemented as a service (e.g., a cloud service provided by one or more remote servers) and another part of system 200 is implemented at a security entity or other network node such as a client device.

In some embodiments, system 200 receives a security policy configuration or a rule (e.g., a firewall rule) for an existing security policy configuration. In the event that system 200 receives a new firewall rule or modification to the firewall rule, system 200 updates the security policy configuration being applied/enforced to the network (e.g., a set of network devices or users, such as a predefined set of devices or types of devices). System 200 enforces the security policy configuration with respect to the network or set of network devices/users.

In some embodiments, system 200 maintains one or more security policy configurations to be enforced with respect to one or more networks or sets of network devices/users. System 200 can analyze the one or more security policy configurations, such as to determine a security posture of a network or security entity, to determine whether a device or application is vulnerable to a particular exploit, to determine relationships among devices or services/applications, etc. In various embodiments, in connection with analyzing or managing the security policy configurations, system 200 determines (e.g., generates) a graph model for a security policy configuration based on the security policy configuration. The graph model comprises a set of graph nodes and interconnections. Each of the graph nodes may correspond to a data object that comprise one or more attributes, including an indication of relationships with one or more other data objects in the graph model.

In some embodiments, system 200 stores the graph model in a graph database. Examples of graph database systems that can be used to store the graph model include Neo4j graph database system, the AnzoGraph® DB graph database system, the Blazegraph™ graph database system, the Cambridge Semantics graph database system, and/or OrientDB database, etc.

System 200 exposes the graph model (e.g., the graph database) to applications, services, or other systems for querying in connection with analyzing the security policy configuration. For example, system 200 can implement an application programming interface (API) to enable the application, service, or other system to query the graph model.

System 200 uses the graph model to analyze the security posture. For example, in response to receiving an indication of a new threat (e.g., a 0-day exploit), system can assess whether a network, security entity, or particular network device is vulnerable to the threat. System 200 may use a machine learning (ML) model to predict whether the network, security entity or network device is exposed to the threat. The ML model may be trained by system 200 using a machine learning process with respect to a training set comprising a plurality of security profile configurations.

In the example shown, system 200 implements one or more modules in connection with enforcing a security policy configuration (e.g., a set of firewall rules), managing or analyzing a security posture for a firewall or other security entity, and/or predicting vulnerabilities to network devices, etc. System 200 comprises communication interface 205, one or more processor(s) 210, storage 215, and/or memory 220. One or more processors 210 comprises one or more of communication module 225, policy configuration obtaining module 227, policy configuration parser module 229, network device discovered module 231, graph model generation module 233, graph model storing module 235, query receiving module 237, query response module 239, ML model module 241, prediction engine module 243, notification module 245, and user interface module 247.

In some embodiments, system 200 comprises communication module 225. System 200 uses communication module 225 to communicate with various nodes or end points (e.g., client terminals, firewalls, DNS resolvers, data appliances, other security entities, etc.), third party services (e.g., to obtain information pertaining to known exploits or known DNS-tunneling campaigns or tools), or user systems such as an administrator system. For example, communication module 225 provides to communication interface 205 information that is to be communicated (e.g., to another node, security entity, etc.). As another example, communication interface 205 provides to communication module 225 information received by system 200. Communication module 225 is configured to receive a security policy configuration or an update to a security policy configuration (e.g., a new firewall rule or an update to a firewall rule), receive queries for analysis with respect to the security policy configuration (e.g., a query to a graph database of a graph model representing the security policy configuration), a characterization of a new threat, an indication of samples (e.g., HTTP requests, URLs, URIs, network traffic, etc.) to be analyzed, such as from network endpoints or nodes such as security entities (e.g., firewalls), database systems, query systems, etc. Communication module 225 is configured to query third party service(s) for information pertaining to (i) network security policy configurations, or (ii) the network traffic classifications (e.g., services that expose information/classifications for signatures/hashes of network traffic such as third-party scores or assessments of maliciousness of particular traffic, a community-based score, assessment, or reputation pertaining to domains or applications, a blacklist for domains, applications, or certain types/signatures of network traffic such as HTTP requests, and/or a whitelist for domains, applications, or other certain types of network traffic such as a list or index of DNS-tunneling campaigns or domains, etc.). For example, system 200 uses communication module 225 to query the third-party service(s) for information pertaining to known exploits or campaigns or tools. Communication module 225 is further configured to receive one or more settings or configurations from an administrator. Examples of the one or more settings or configurations include configurations of a rule for handling traffic that is classified as malicious traffic, a process determining whether a particular type of traffic (e.g., a particular HTTP request) is permitted, malicious, benign, etc., a format or process according to which a feature vector or embedding is to be determined, a set of predefined signatures to be assessed or counted, information pertaining to a whitelist of domains, applications, nodes, or signatures for traffic (e.g., traffic that is not deemed suspicious or malicious, traffic that is not deemed DNS-tunneling traffic, traffic that is not deemed to match a known DNS-tunneling campaign or tool, etc.), information pertaining to a blacklist of domains, applications, nodes, or signatures for traffic (e.g., traffic that is deemed to be suspicious or malicious and for which traffic is to be quarantined, deleted, or otherwise to be restricted from being executed/transmitted), etc.

In some embodiments, system 200 comprises policy configuration obtaining module 227. System 200 uses policy configuration obtaining module 227 to obtain (e.g., receive) a security policy configuration, such as from an administrator or another system that configures the security posture for a network or security entity. Obtaining the security policy configuration may include receiving an update to a security policy configuration, such as a new or updated firewall rule.

In some embodiments, the security policy configuration includes an indication/definition of a set of network devices to be managed (e.g., mobile devices and/or client devices) or to enforce the security policy configuration (e.g., security entities, such as firewalls, etc.). The firewall rule may include a set of conditions with respect to traffic (e.g., a maliciousness classification) for enforcing a particular active measure or action (e.g., quarantine, etc.).

In some embodiments, system 200 comprises policy configuration parser module 229. System 200 uses policy configuration parser module 229 to parse a received security policy configuration, such as to identify a set of conditions and corresponding active measures. For example, policy configuration parser module 229 determines one or more rules (e.g., firewall rules) in the security policy configuration, a set of network devices or a set of network traffic types (e.g., traffic from a particular domain(s), traffic for a particular application or service, etc.) that is subject to the rule, and/or a set of actions or active measures to be performed with respect to the set of network devices and/or the set of network traffic types.

In some embodiments, a firewall rule or a security policy configuration is defined according to a predefined schema. The policy configuration parser module 229 can parse the security policy configuration based at least in part on the predefined schema. The predefined schema may include one or more fields pertaining to one or more attributes for network devices, network traffic types, and/or firewall rules.

In some embodiments, system 200 comprises network device discovery module 231. System 200 uses network device discovery module 231 to discover network devices (e.g., managed devices such as mobile devices or client device, or security rules such as firewalls, routers, etc.). In some embodiments, network device discovery module 231 discovers the network devices based on information received from another service. Device discovery, particularly discovery of IoT devices, is described in U.S. Patent Application Publication No. 2022/0095092, the entirety of which is hereby incorporated herein for all purposes. Device discovery may be performed actively, passively, or a combination of active and passive discovery techniques. System 200 uses network device discovery module 231 to perform device discovery to determine the various network assets that communicate with, connect to, or are part of, a network. For example, network device discovery module 231 invokes a device discovery service to perform the device discovery.

In some embodiments, the device discovery service performs device discovery by obtaining and analyzing network logs (e.g., traffic logs) that may be maintained by various network assets. For example, a firewall associated with the network maintains network logs, which stores data such as information pertaining to network traffic between a router and the network. Various other network assets may store network logs. The device discovery service can query the network assets for the network logs and use the network logs to determine a network topology and information indicating communications between network assets, etc.

In some embodiments, the device discovery service uses machine learning techniques to analyze the collected network logs and to identify network assets and determine a network topology. As an example, the device discovery service implements a machine learning model to classify devices (e.g., device type, make, model, vendor, etc.) and to identify metadata associated with the devices.

In some embodiments, the device discovery service is integrated with another service or system, such as a third-party system. As an example, the device discovery service is integrated or connected to an asset management system, and the device discovery service can obtain information pertaining to network assets managed by the asset management system. The information obtained from other services or systems can be used to supplement the information obtained from the network logs.

Additionally, or alternatively, in various embodiments the device discovery service polls devices (e.g., network assets) for supplemental information. The polling of devices may be used in conjunction with analysis of network logs to supplement the information in the network logs.

Additionally, or alternatively, in various embodiments the device discovery service performs a crawling of the network structure. The device discovery service can perform the crawling to determine the integrations or SMTP integrations, and to determine the access point (e.g., switch, router, etc.) to which an IoT device is connected.

After the network assets are discovered (e.g., after performing device discovery), system 200 uses a network topology determination service to determine a network topology. The network topology determination service uses the information obtained during device discovery to map the network topology. For example, the network topology determination service uses the device discovery information to determine connections between network assets or behavior of the network assets and/or the network. The network topology determination service may store a current network topology state and/or a future network topology state. For example, the network topology determination service can perform a simulation (e.g., based on user-defined simulation criteria) to assess a future network topology state and/or a manner in which the behavior of the network assets is changed. An example of a simulation is the configuration or placement of a new firewall or removal of an existing firewall in order to assess how the behavior of the network or certain network assets correspondingly changes. The mapping of a current network topology state and a future network topology state enables system 200 to determine what would happen if the simulated changes were made to the network environment.

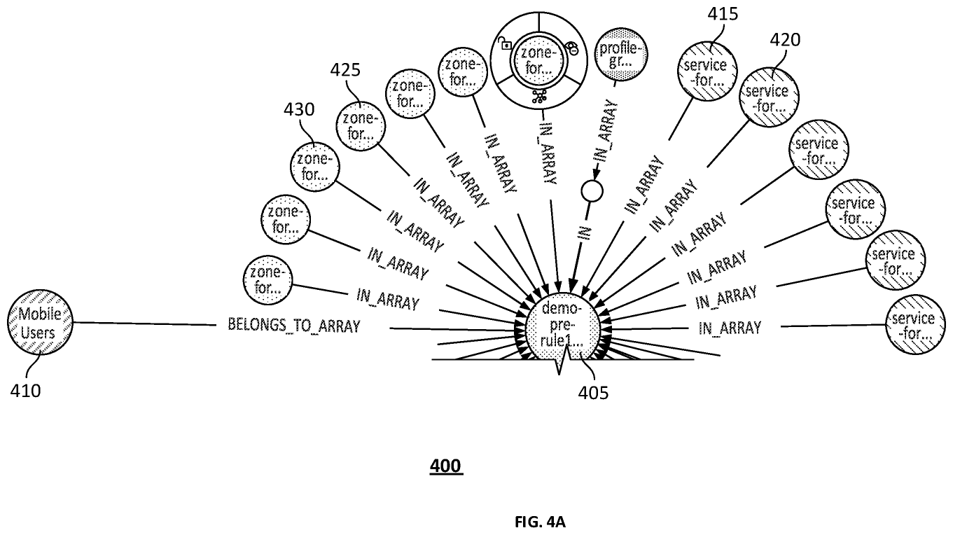

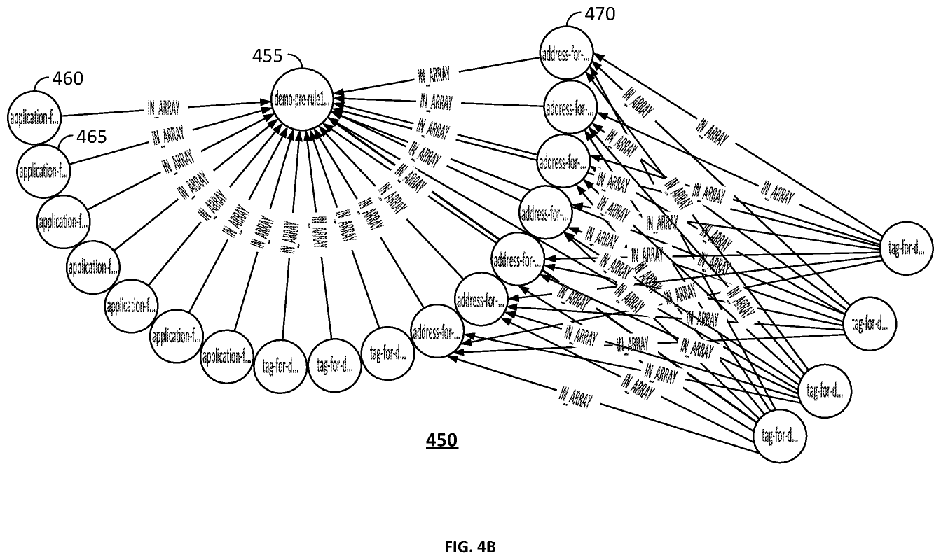

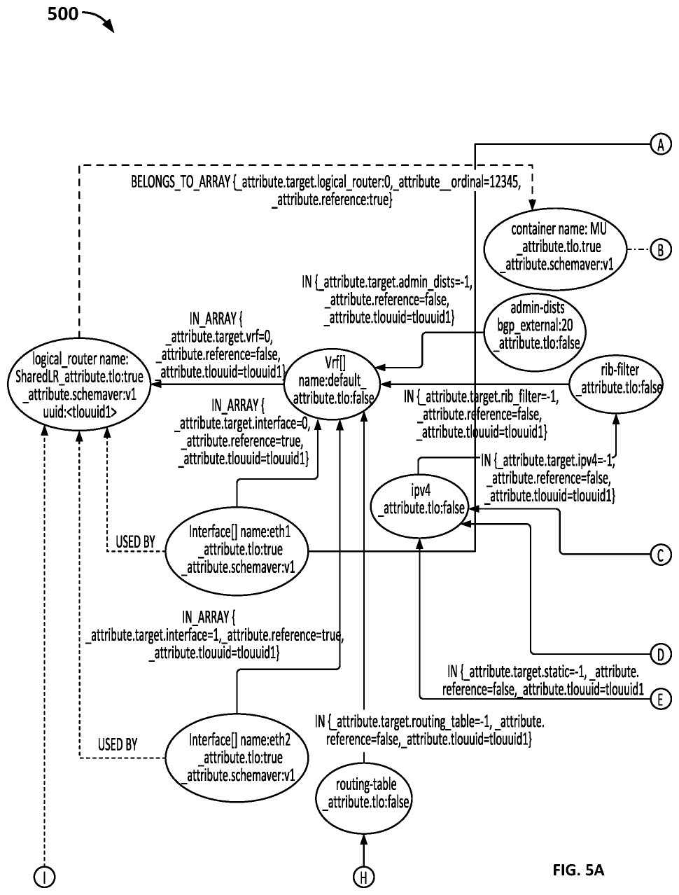

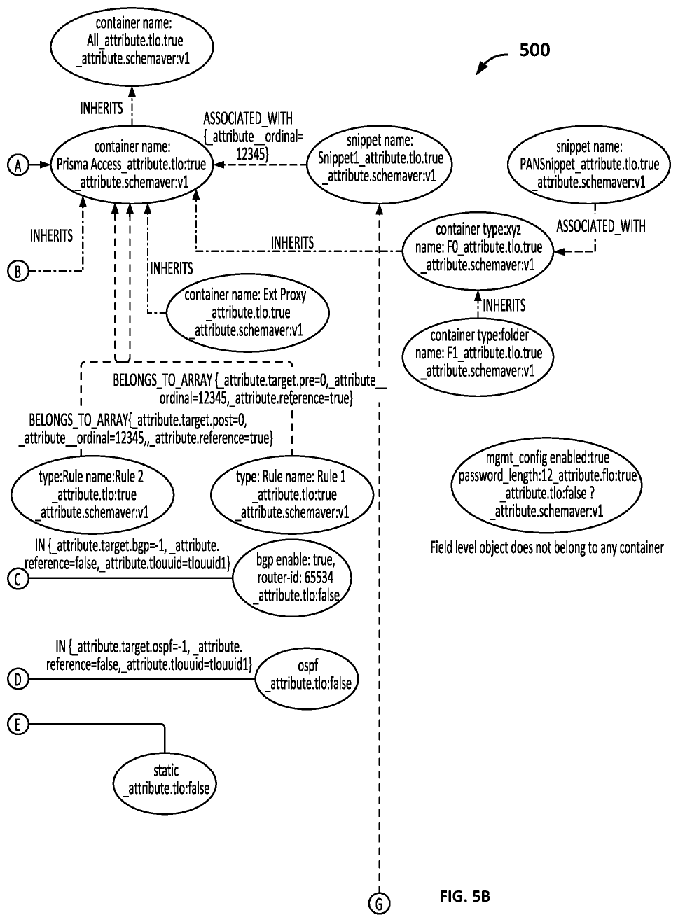

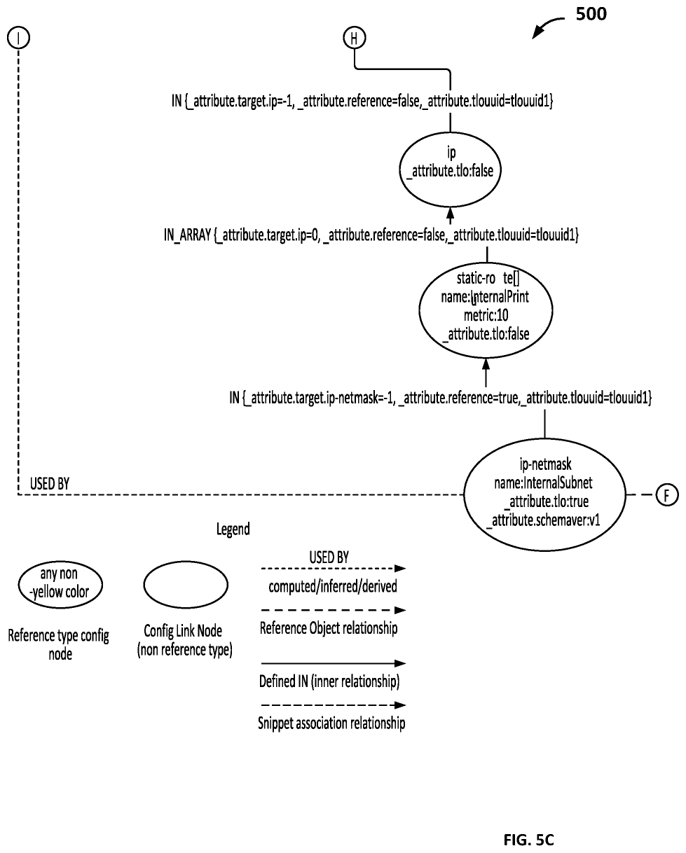

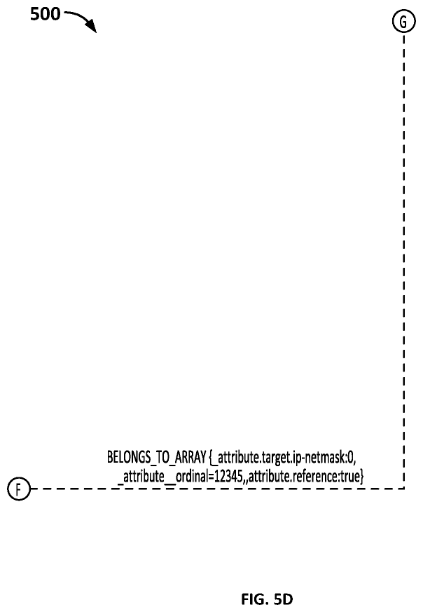

In some embodiments, system 200 comprises graph model generation module 233. System 200 uses graph model generation module 233 to generate a graph model to represent the security policy configuration, such as the graph models illustrated in FIGS. 4A-4B and 5. The graph model generation module 233 generates the graph model based on one or more of (i) a set of network devices/assets associated with the network, (ii) a set of network traffic types that may be communicated across the network, (iii) a set of rules (e.g., firewall rules), (iv) a set of conditions for determining whether to enforce a particular rule for a network device/asset or network traffic type, (v) a set of active measures to be performed in connection with enforcing the particular rule, (vi) a network topology for the set of network devices/assets, etc.

In some embodiments, the graph model comprises a set of graph nodes and interconnections. Each of the graph nodes may correspond to a data object that comprise one or more attributes, including an indication of relationships with one or more other data objects in the graph model.

In some embodiments, a node in the graph model corresponds to a specific firewall rule or a group of related rules, encapsulating information such as source and destination addresses, protocols, and actions. Directed edges between nodes in the graph model signify the order of rule evaluation and the flow of traffic between different policy components, offering a visual depiction of the policy execution sequence.

The data objects in the graph model may be defined according to a predefined schema, such as the definition of data object according to a plurality of attributes or fields in the schema.

In some embodiments, system 200 comprises graph model storing module 235. System 200 uses graph model storing module 235 to store the graph model associated with (e.g., representing) the security policy configuration. In some embodiments, graph model storing module 235 stores the graph model in a graph database. Examples of graph database systems that can be used to store the graph model include Neo4j graph database system, the AnzoGraph® DB graph database system, the Blazegraph™ graph database system, the Cambridge Semantics graph database system, and/or OrientDB database, etc.

In some embodiments, graph model storing module 235 stores the graph model in a graph database in a manner in which the graph model may be queried, explored, or analyzed by a user or another system or service.

In some embodiments, system 200 comprises query receiving module 237. System 200 uses query receiving module 237 to receive a query with respect to the graph model. Examples of queries that may be received and processed include: (i) a query to detect whether an object/network device is visible in a firewall device policy, (ii) a query to determine a relationship between two different nodes or network devices in the graph model, (iii) a query to detect whether a particular node is vulnerable to an identified exploit, (iv) a query to determine whether a node is exposed to particular traffic or a particular application (v) a query to determine the nodes associated with a particular IP address, and/or (vi) a query to determine whether a firewall protects against a particular exploit, etc.

In some embodiments, system 200 exposes the graph model to another application or service. For example, system 200 exposes the graph model via an application programming interface (API). Another application or service can use the API to submit a query to query receiving module 237.

In some embodiments, system 200 comprises query response module 239. System 200 uses query response module 239 to obtain a response to a query received via query receiving module 237. For example, in response to receiving the query, query response module 239 queries the graph model (e.g., the graph database for the graph model) to obtain information responsive to the query. In some embodiments, in response to receiving the query, query receiving module 237 invokes prediction engine module 243 to obtain a prediction that is responsive to the query (e.g., a prediction based on querying a machine learning model or classifier).

In some embodiments, system 200 comprises ML model module 241. System 200 uses ML model module 241 to train an ML model to generate a prediction with respect to the security policy configuration or the graph model. For example, the ML model can predict how traffic will be handled with respect to a newly identified threat (e.g., a 0-day exploit), etc. As another example, the ML model can predict network devices/assets that are exposed to a particular application or service.

In some embodiments, ML model module 241 comprises a ML training pipeline. The ML training pipeline may extract training graph from the configuration graph database using commands such as ‘call db.schema( )’. The object types, relationship types, policy hit counts, etc. can be classified into a graph projection with vector indexes for language model searches. This graph projection may essentially be a knowledge graph weighted with configured policies and vulnerabilities. The resulting graph projection can be thought of as a knowledge graph that can be queried by an LLM for textual or subgraph.

There may be other possibilities to enrich and extract information from the graph model. The fact that the data is modeled in this way allows for the other processes or techniques to be used to extract such information.

In some embodiments, the system receives a query from a user or another process or system. The system uses an LLM smart search tool to process the query and to further query the graph model. The graph model responds to the query and the LLM smart search tool processes the responsive information and the query to generate an answer to the initial query.

In some embodiment, the ML model is trained using a machine learning process. Examples of machine learning processes that can be implemented in connection with training the classifier(s) include random forest, linear regression, support vector machine, naive Bayes, logistic regression, K-nearest neighbors (KNN), decision trees, gradient boosted decision trees, K-means clustering, hierarchical clustering, density-based spatial clustering of applications with noise (DBSCAN) clustering, principal component analysis, a convolutional neural network (CNN), etc. Various other types of machine learning processes can be implemented.

In some embodiments, system 200 comprises prediction engine module 243. System 200 uses prediction engine module 243 to determine a prediction with respect to a security policy configuration. An example of the prediction includes a prediction of how traffic for a particular application or service or traffic from a particular domain or network asset is to be handled. As another example, the prediction includes a predicted set of network devices/assets that are exposed to an application or service or from a particular domain/originating address. In some embodiments, determining the prediction includes querying the ML model trained/managed by ML model module 241.

In some embodiments, system 200 comprises notification module 245. System 200 uses notification module 245 to generate and/or provide a notification to another application, service, or system, such as a client system. The notification can be generated based at least in part on (i) determining that malicious traffic is detected/handled, (ii) identifying a new threat (e.g., a 0-day exploit), (iii) determining a vulnerability in the system with respect to a particular threat (e.g., the new threat), (iv) determining that a particular network device/asset is exposed to a particular threat, (v) determining that security policy configurations, or rules within the security policy configurations, are inconsistent or otherwise conflict, (vi) determining a recommended measure for resolving a detected vulnerability, (vii) determining a recommended firewall rule or configuration update to resolve a detected inconsistency or conflict, etc.,

System 200 may use notification module 245 to provide to one or more security entities (e.g., a firewall), nodes, or endpoints (e.g., a client terminal) an update to a whitelist of traffic, such as a whitelist of IP addresses (e.g., IP addresses from which HTTP requests originate) or a whitelist of traffic signatures (e.g., hashes for samples deemed to be benign). According to various embodiments, notification module 245 obtains a hash, signature, or other unique identifier associated with the domain (e.g., a webpage for the domain) or network traffic, and provides the indication of whether the sample is malicious in connection with the hash, signature, or other unique identifier associated with the sample.

According to various embodiments, the hash of a sample corresponds to a hash of an IP address (e.g., the IP address from which the HTTP request originates), a hash of header information, a hash of header information that is formatted according to a predefined format, etc. A security entity or an endpoint may compute a hash of a sample or traffic monitored/analyzed. The security entity or an endpoint may determine whether the computed hash corresponding to the sample is comprised within a set such as a whitelist of benign traffic, and/or a blacklist of traffic, etc. If a signature for a received sample is included in the set of signatures for samples previously deemed malicious (e.g., a blacklist of samples), the security entity or an endpoint can prevent the transmission of the corresponding traffic or prevent traffic to/from a client device from which traffic was collected.

In some embodiments, system 200 comprises user interface module 247. System 200 uses user interface module 247 to configure and provide a user interface to a user, such as to a client system used by the user. User interface module 247 configures a user interface to provide a representation (e.g., visualization) of the graph model, information stored in the graph database corresponding to the graph model, information pertaining to a query response.

In some embodiments, system 200 comprises is configured to enforce one or more security policies with respect to information such as network traffic, files, etc. System 200 may perform an active measure with respect to the network traffic in response to detecting the that the traffic corresponds to malicious traffic. Additionally, or alternatively, system 200 performs a remedial measure in response to detecting that a traffic sample matches a known DNS-tunneling campaign or tool. System 200 enforces the one or more security policies based on whether the file is determined to be malicious. Firewalls typically deny or permit network transmission based on a set of rules. These sets of rules are often referred to as policies (e.g., network policies, network security policies, security policies, etc.). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall rules or firewall policies, which can be triggered based on various criteria, such as are described herein). A firewall can also filter local network (e.g., intranet) traffic by similarly applying a set of rules or policies. Other examples of policies include security policies such as ones requiring the scanning for threats in incoming (and/or outgoing) email attachments, website content, files exchanged through instant messaging programs, and/or other file transfers.

According to various embodiments, storage 215 comprises one or more of filesystem data 260, graph model 265, and/or graph model database 270. Storage 215 comprises a shared storage (e.g., a network storage system) and/or database data, and/or user activity data.

In some embodiments, filesystem data 260 comprises a database such as one or more datasets (e.g., one or more datasets for domains, datasets comprising samples of network traffic, mappings of indications for network traffic or predicted traffic classifications for network traffic to the network traffic or hashes, signatures or other unique identifiers of the network traffic, such as a signature for the domains, mappings of indicators of benign traffic to hashes, signatures or network traffic, datasets for a set of profile seeds, datasets for a set of profiles generated based on the profile seeds, dataset for network traffic generated based on the profile seeds, etc.). Filesystem data 260 comprises data such as historical information pertaining to HTTP request data or network traffic, a whitelist of network traffic profiles (e.g., hashes or signatures for the HTTP request data) or IP addresses deemed to be safe (e.g., not suspicious, benign, etc.), a blacklist of network traffic profiles deemed to be suspicious or malicious, etc.

Graph model 265 comprises data pertaining to a security policy configuration. For example, graph model 265 comprises a representation of the security policy configuration managed/maintained by system 200.

Graph model database 270 comprises information pertaining to a graph model, such as graph model 265.

According to various embodiments, memory 220 comprises executing application data 275. Executing application data 275 comprises data obtained or used in connection with executing an application such as an application executing a hashing function, an application to obtain or analyze network traffic, an application to generate a graph model based on a security policy configuration, an application to store the graph model in a graph database, an application to query a graph database, etc. Other applications comprise any other appropriate applications (e.g., an index maintenance application, a communications application, a machine learning model application, an application for detecting suspicious input strings, suspicious files, or suspicious traffic, an application for detecting malicious network traffic or malicious/non-compliant applications such as with respect to a corporate security policy, a document preparation application, a report preparation application, a user interface application, a data analysis application, an anomaly detection application, a user authentication application, a security policy management/update application, etc.).

FIG. 3 is a block diagram of system for maintaining a graph database associated with a graph model for a security policy configuration of a network according to various embodiments. According to various embodiments, system 300 is implemented in connection with system 100 of FIG. 1 and/or system 200 of FIG. 200. System 300 may be implemented at least part of system 200 of FIG. 2. In various embodiments, system 300 is implemented in connection with process 700 of FIG. 7, process 800 of FIG. 8, process 900 of FIG. 9, process 1000 of FIG. 10, and/or process 1100 of FIG. 11.

In the example shown, system 300 is configured to generate a graph model that can be exposed to another system or service for querying. System 300 comprises model generator 315 that generates graph model based at least in part on a predefined schema definition 305 and a graph data model template 310. As illustrated, at 307, model generator 315 obtains schema definition 305 and at 312 model generator 315 obtains graph data model template 310. In response to obtaining schema definition 305 and graph data model template 310, model generator 315 generates the graph model. The graph model represents a security policy configuration, such as a particular firewall rule and the relationships between the firewall rule and other application or services implemented or exposed by the system, or between the firewall rule and other network devices/assets.

In response to generating the graph model, system 300 stores the graph model in graph database 340. For example, at 346, model generator 315 stores the graph model in graph database 340. Examples of graph database systems that can be used to store the graph model include Neo4j graph database system, the AnzoGraph® DB graph database system, the Blazegraph™ graph database system, the Cambridge Semantics graph database system, and/or OrientDB database, etc.

System 300 exposes one or more of the graph model generated by model generator 315 or information stored in graph database 340 to another application, service, or system. In the example shown, system exposes the graph model or the graph database to applications 330 via API 320. In various embodiments, API 320 is implemented as a Protobuf format, a REST API, a GQL API, and/or a JQuery API.

At 332, applications 330 submit a query to API 320, which in turn queries the graph model at 322 or graph database 340 at 344. In response to the query from API 320, at 324, model generator 315 provides a result or responsive information to API 320. Additionally, or alternatively, in response to the query from API 320 at 342, at 344 graph database 340 provides a result or responsive information to API 320. In response to receiving a result for the query from the graph model or graph database, at 334, API 320 returns the result to applications 330.

In some embodiments, predefined schema definition 305 and graph data model template 310 are inputs to model generator 315. Predefined schema definition 305 comprises firewall device object type, their properties, validators and container hierarchy information, etc. Graph data model template 310 comprises graph node types and relationships for object types, etc. Model generator 315 combines the information from predefined schema definition 305 and graph data model template 310 and generates a set of schema artifacts that combines graph model as a set of YAML files, graph relationships based on object type. In some embodiments, model generator 315 also generates prototypes in REST/protobuf API modes where a client application can create instances of object types, perform workflows CREATE/READ/UPDATE/DELETE/LIST etc. In some embodiments, application 330 is an end application such as an API gateway or user interface, or a machine learning training module, etc.

In various embodiments, the system exposes the graph model to queries to (i) find a specific object or configuration (e.g., where the object/configuration is referenced, including recursively finding the object), (ii) find objects where specific IP addresses are used (e.g., even when IP addresses are part of an IP range, an IP netmask, or wildcard mark), (iii) search for policies that are covered for specific common vulnerabilities and exposures (CVEs), (iv) search for all policies (e.g., across various rulebases) that match combination of particular match criteria (e.g., an application, a service, a URL, a source and/or destination IP, a user, etc.), and (iv) a search for a predefined configuration (e.g., a predefined snippet) context. The graph model is exposed in a manner that an administrator or other system can recursively expand objects in the graph model to find references for objects within the search results. The graph model can be recursively searched for a CVE signature (e.g., where the signature is used in the graph model or set of rules), a profile (e.g., where the profile is used in in the graph model or set of rules), a profile group (e.g., where the profile group is used).

In some embodiments, the system exposes the graph model to perform a global-find and where-used search. The system generates initial search results from the global-find, which includes basic information of objects (e.g., device/application/service names, UUID, scope-information, etc.) of the objects that are responsive to the search. The system can subsequently search on objects responsive to the initial search to obtain subsequent objects that are referencing the objects responsive to the initial search. The initial search can be optionally limited by the user with filers such as context, scope type, scope name, object type, etc.

Results to queries searching the graph model can include an object-type, a name (e.g., a device name or an application name, etc.), a UUID, location information, and other information such as where the object is used, when the object was last updated, etc.

In response to receiving a query against the graph model, the system can split the query into a set of sub-queries and then combine the results to provide the information responsive to the query. For example, the system can split the query into one or more of a regular string search (e.g., a set of regex statements such as for the object name, comments, object description, etc.), an IP (IPV4) search, an IP (IPV6) search, and/or a name-value search.

FIGS. 4A and 4B show an example of a graph model for a security policy configuration that includes a plurality of network parameters according to various embodiments. In the example shown, a graph model comprises a first subset 400 and a second subset 450. The graph model collectively represented by first subset 400 and second subset 450 illustrates a sample firewall rule subgraph and its constituents and their respective relationships to firewall rule 405.

The node representing firewall rule 405 defines a firewall rule for allowing/denying network traffic packets for a set of services or applications, such as from specified network zones (e.g., a trusted zone, the internet, etc.). Examples of graph nodes for the set of services or applications include graph node 415 and graph node 420. Examples of graph nodes for specified network zones include graph node 425 and graph node 430. The network traffic may be communicated on specific address (e.g., VLAN) segments.

As illustrated in FIG. 4A, firewall rule 405 belongs to graph node 410. In the example shown, graph node 410 corresponds to the “mobile users” folder which includes a security policy configuration for a set of mobile users/devices. Firewall rule 405 thus is applied to all traffic for mobile users/devices passing through the firewall.

As illustrated in FIG. 4B, the second subset 450 of the graph model illustrates a relationship between firewall rule 455 and a set of applications, such as denoted by node 460 and node 465. Further, the second subset 450 of the graph model illustrates the relationship between firewall rule 455 and an address such as the address for node 470.

In some embodiments, in the graph model, a graph node and relationships are indicated with additional information to interpret the configuration schema.

FIGS. 5A-5D collectively show an example of a graph model according to various embodiments. In the example shown, graph model 500 enables the system to manage configurations (e.g., security policy configurations such as a firewall) in an extensible and scalable manner. Graph model 500 comprises a plurality of data objects. A data object comprises information that describes itself and its relationships to other data objects in graph model 500. In some embodiments, each data object in graph model 500 has an associated unique identifier (e.g., a UUID). The system can use graph model 500 to obtain insight into whether the configuration protects the corresponding network from a set of threats. A node in graph model 500 may comprise/correspond to a plurality of data objects.

In some embodiments, the system implements a predefined protocol/syntax/schema for populating data objects comprised in graph model 500. As an example, a data object in the graph model comprises one or more attributes. The graph database (e.g., a data object within the graph database) may store a relationship between a first data object and one or more other data objects in the graph model. For example, a data object may store information indicating that the data object inherits one or more attribute from another data object(s) (e.g., node in the graph model). As another example, the data object may store information indicating that the data object is associated with one or more other data objects. As yet another example, the data object may store information indicating that the data object belongs to a particular array. As yet another example, the data object may store information indicating that the data object is used by one or more other data objects in the graph model (e.g., the data object is used to compute, infer, or derive the other data object).

In some embodiments, a data object comprises one or more relationship attributes according to a convention that allows the system to infer and perform aspects of traversing the graph for the configuration (e.g., the security policy configuration). Examples of relationship attributes include: (i) an indication that data object has a relationship in which the data object is used by another object such as to determine a value/attribute for the other data object, (ii) an indication that the data object has a reference object relationship, (iii) an indication that the data object is defined in another data object (e.g., that the data object has an inner relationship with the other data object), and (iv) an indication that the data object has a snippet association relationship with another data object.

In some embodiments, the schema for data objects can includes a set of fields, such as represented as attribute.<target>.<fieldname>=<createdarrayorder>. The target fieldname which indicates that a particular data object points to another data objects inner field. As an example, an address may point to a rule node's source or destination. The field denoted by <createdarrayorder> can be used to specify a monotonically increasing number that can be sorted to obtain the object order at create in which items were inserted into an array. The monotonic counter can be obtained from a high-resolution time or from a distributed autonomic counter.

In some embodiments, the schema includes a field denoted by _attribute_ordinal=<ordinal>. The object type order can be important for security policy configurations. The object order can be changed using move operations (e.g., up, down, before, after, etc.). This relationship ordinal can maintain an int64 number for a given object type belonging to a location (e.g., a security rule in the “All” container). When data objects are read, the system issues an “order by: _attribute_ordinal” instruction.

In some embodiments, the schema includes a field _attribute.<reference>=<true/false>. This field may be used to indicate whether the relationship for a data object is with a node (e.g., data object) that is a top level object (TLO) node type.

In some embodiments, the schema includes a field _attribute.tlouuid=tlouuid1. This field may be used to indicate the unique identifier for the TLO data object with which a particular data object has a relationship. This field enables efficient subgraph directed acyclic graph (DAG) queries without knowing the subgraph depth. This field may enable the subgraph to stop traversing the graph model for the subgraph DAG query at the first reference node. The reference node may be a group with several data objects (e.g., thousands of data objects).

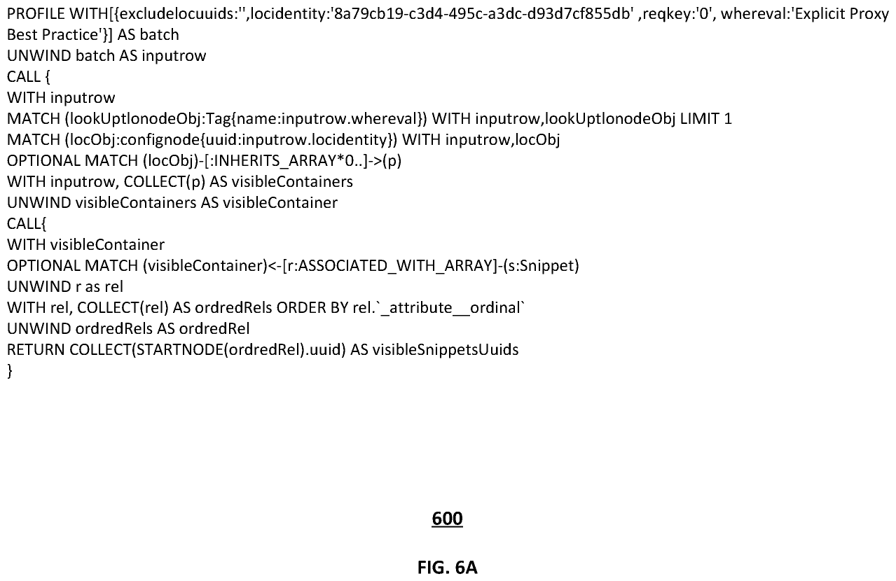

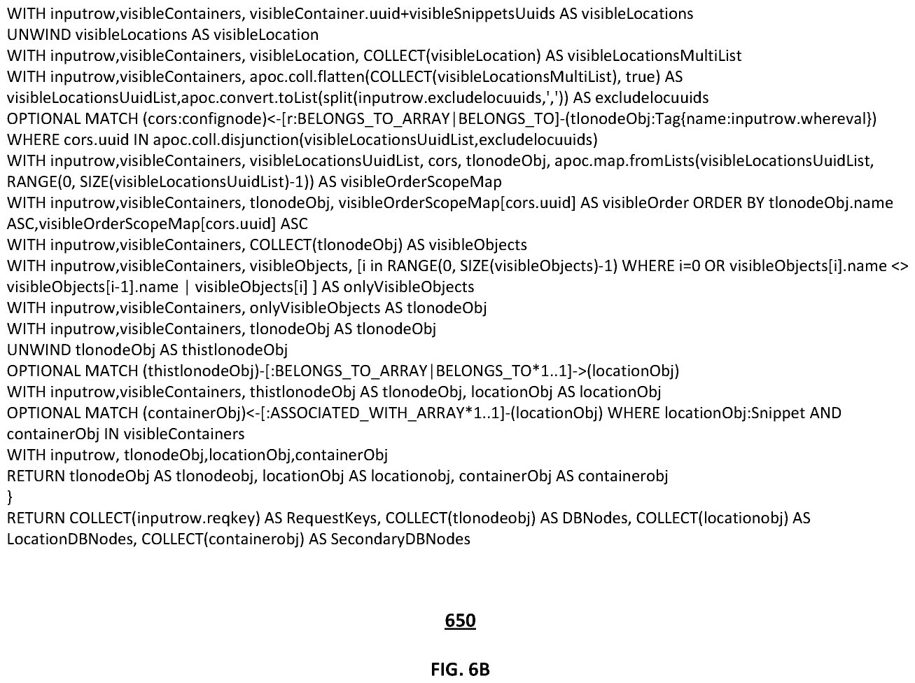

FIGS. 6A and 6B show an example of a graph model query to determine whether a security object is visible for a specific firewall device according to various embodiments. In the example shown, the graph model query corresponding to code snippet 600 and code snippet 650 is a query for determine whether a security object is visible for a specific firewall device. The system may receive the query from another service, another system, or an application running on the system or accessible via the network.

In response to receiving the query, which is collectively provided in code snippet 600 and code snippet 640, the system queries the graph model for responsive data. For example, the system queries a graph database that represents the graph model.

In some embodiments, the system receives the query from another application, process, or service running on the system, or from another system. For example, the system may comprise an application programming interface (API) via which the query is received.

FIG. 7 is a flow diagram of a method for analyzing a security policy configuration for a network according to various embodiments. In various embodiments, process 700 is implemented at least in part by system 100 of FIG. 1 and/or system 200 of FIG. 2.

At 705, the system generates a graph model using a model generator for a security policy configuration. The security policy configuration includes a plurality of network parameters. The graph model may be stored in a graph database, such as according to the Neo4j graph database system, the AnzoGraph® DB graph database system, the Blazegraph™ graph database system, the Cambridge Semantics graph database system, and/or OrientDB database, etc.

At 710, the system processes a query and generates a response using the graph model. The system can receive the query from another system, service, or process. In response to receiving the query, the system determines responsive data to the query based at least in part on a graph model. For example, the system in turn queries a graph database in which the graph model is stored and generates a response to the query.

Examples of queries that may be received and processed include: (i) a query to detect whether an object/network device is visible in a firewall device policy, (ii) a query to determine a relationship between two different nodes or network devices in the graph model, (iii) a query to detect whether a particular node is vulnerable to an identified exploit, (iv) a query to determine whether a node is exposed to particular traffic or a particular application (v) a query to determine the nodes associated with a particular IP address, (vi) a query to determine whether a firewall protects against a particular exploit, etc.

At 715, a determination is made as to whether process 700 is complete. In some embodiments, process 700 is determined to be complete in response to a determination that no further queries are received, no further queries are to be processed, no further security policy configurations are to be analyzed, no further graph models are to be generated, an administrator indicates that process 700 is to be paused or stopped, etc. In response to a determination that process 700 is complete, process 700 ends. In response to a determination that process 700 is not complete, process 700 returns to 705.

FIG. 8 is a flow diagram of a method for querying a graph model pertaining to a security policy configuration for a network according to various embodiments. In various embodiments, process 800 is implemented at least in part by system 100 of FIG. 1 and/or system 200 of FIG. 2.

At 805, the system generates a graph model using a model generator for a security policy configuration. The security policy configuration includes a plurality of network parameters.

At 810, the system receives a query with respect to the graph model. Examples of queries that may be received include: (i) a query to detect whether an object/network device is visible in a firewall device policy, (ii) a query to determine a relationship between two different nodes or network devices in the graph model, (iii) a query to detect whether a particular node is vulnerable to an identified exploit, (iv) a query to determine whether a node is exposed to particular traffic or a particular application (v) a query to determine the nodes associated with a particular IP address, (vi) a query to determine whether a firewall protects against a particular exploit, etc.

At 815, the system obtains responsive data from the graph database.

At 820, the system provides the query response. The system provides the query response to the system, service, or process from which the query is received or from which process 800 is invoked.

At 825, a determination is made as to whether process 800 is complete. In some embodiments, process 800 is determined to be complete in response to a determination that no further queries are received, no further queries are to be processed, no further security policy configurations are to be analyzed, an administrator indicates that process 800 is to be paused or stopped, etc. In response to a determination that process 800 is complete, process 800 ends. In response to a determination that process 800 is not complete, process 800 returns to 805.

FIG. 9 is a flow diagram of a method for querying a graph model pertaining to a security policy configuration for a network according to various embodiments. In various embodiments, process 900 is implemented at least in part by system 100 of FIG. 1 and/or system 200 of FIG. 2.

At 905, the system generates a graph model using a model generator for a security policy configuration. The security policy configuration includes a plurality of network parameters.

At 910, the system stores the graph model in a graph database. In some embodiments, the graph database is based on one or more of (i) the Neo4j protocol or graph database system, (ii) the ACID graph database system (e.g., according to the ACID NoSQL protocol), (iii) the AnzoGraph® DB graph database system. (iv) the Blazegraph™ graph database system, (v) the Cambridge Semantics graph database system, and/or (vi) OrientDB database system. Various graph database systems or protocols may be used.

According to various embodiments, data elements stored in the graph database include nodes, edges which connect nodes to one another, and attributes of nodes and edges. Nodes and edges can be labelled. Labels can be used to narrow searches/queries against the information stored in the graph database.

At 915, the system receives a query with respect to the graph model. Examples of queries that may be received include: (i) a query to detect whether an object/network device is visible in a firewall device policy, (ii) a query to determine a relationship between two different nodes or network devices in the graph model, (iii) a query to detect whether a particular node is vulnerable to an identified exploit, (iv) a query to determine whether a node is exposed to particular traffic or a particular application (v) a query to determine the nodes associated with a particular IP address, (vi) a query to determine whether a firewall protects against a particular exploit, etc.

At 920, the system obtains responsive data from the graph database.

At 925, the system provides the query response. The system provides the query response to the system, service, or process from which the query is received or from which process 900 is invoked.

At 930, a determination is made as to whether process 900 is complete. In some embodiments, process 900 is determined to be complete in response to a determination that no further queries are received, no further queries are to be processed, no further security policy configurations are to be analyzed, an administrator indicates that process 900 is to be paused or stopped, etc. In response to a determination that process 900 is complete, process 900 ends. In response to a determination that process 900 is not complete, process 900 returns to 905.

FIG. 10 is a flow diagram of a method for predicting a security posture of a network based at least in part on a graph model for a security policy configuration according to various embodiments. In various embodiments, process 1000 is implemented at least in part by system 100 of FIG. 1 and/or system 200 of FIG. 2.

At 1005, the system determines to obtain a prediction with respect to a security posture of an enterprise network. According to various embodiments, the system determines to obtain the prediction based at least in part on one or more of (i) receiving request for analyzing security posture of a network device or of the network, (ii) determining that a security policy configuration is updated, (iii) determining that the network configuration has been updated/changed, (iv) determining that a new application is to be deployed/exposed to devices on the network, (v) determining that a new threat has been identified/characterized, etc.

In some embodiments, another system, service, or process invokes process 1000 based on a user request to determine whether the network device or network is protected from a particular CVE (e.g., a 0-day exploit). As another example, the request may be based on a particular threat and be a request for a determination of whether a firewall protects against the threat (e.g., a firewall having the security profile configuration, etc.).

In some embodiments, the system determines to obtain a prediction in response to determining that a new threat is identified. For example, the system receives periodic or streams of data pertaining to identified threats or 0-day exploits, and in response to determining that a new threat/exploit has been characterized, the system determines to predict whether the network or a particular device is vulnerable to such threat/exploit.

At 1010, the system obtains information pertaining to a graph model for the enterprise network. The system can query a graph database for the information pertaining to the graph model.

At 1015, the system queries a machine learning model for the prediction. As an example, the system determines features or embeddings based on the information pertaining to the graph model, and uses those features or embeddings in connection with requesting the machine learning model (e.g., a classifier) to provide a prediction (e.g., a classification of a security posture, etc.).

At 1020, the system obtains the prediction from the machine learning model.

At 1025, the system provides the prediction. The system may provide the prediction to the system, service, or process that caused process 1000 to be invoked. For example, the system provides the prediction to a user interface for a client device associated with a user request for the prediction (e.g., a request to analyze a vulnerability of a network device, etc.). As another example, the system provides the prediction to a service that invoked process 1000, such as in response to a determination that the security policy configuration for the network has changed. The service may then provide a notification to an administrator or user of the prediction (e.g., if the prediction indicates a new vulnerability is created based on the update to the security policy configuration, the system provides a notification/indication).

At 1030, a determination is made as to whether process 1000 is complete. In some embodiments, process 1000 is determined to be complete in response to a determination that no further predictions are to be made, no further updates to the security profile configuration are to be analyzed, no further security policy configurations are to be analyzed, an administrator indicates that process 1000 is to be paused or stopped, etc. In response to a determination that process 1000 is complete, process 1000 ends. In response to a determination that process 1000 is not complete, process 1000 returns to 1005.

FIG. 11 is a flow diagram of a method for training a model according to various embodiments. In various embodiments, process 1100 is implemented at least in part by system 100 of FIG. 1 and/or system 200 of FIG. 2.

At 1105, the system obtains information pertaining to security policy configurations. In some embodiments, the system obtains graph models for various networks, or graph databases corresponding to the graph models. The system may use the graph database to determine relationships between nodes in a graph model for the security policy configuration of a network.

At 1110, the system determines one or more relationships between characteristics of the security policy configurations and a security posture of a network. The system processes the information obtained from the graph models or graph databases, and determines features or embeddings for the various graph models. For example, the system determines features for relationships between graph models and various security postures of networks.

At 1115, the system trains a model for detecting common exploits and vulnerabilities in a network. The system implements a machine learning process to train a model for detecting common exploits and vulnerabilities in a network. For example, the model can be a classifier for providing predictions of characteristics of a security posture for a network. For example, the model can be used to predict whether a certain node (e.g., network device) is exposed to an application or other node in the network.

Examples of machine learning processes that can be implemented in connection with training the model include random forest, linear regression, support vector machine, naive Bayes, logistic regression, K-nearest neighbors, decision trees, gradient boosted decision trees, K-means clustering, hierarchical clustering, density-based spatial clustering of applications with noise (DBSCAN) clustering, principal component analysis, etc.

At 1120, the system deploys the model. The system stores the model and exposes the model to queries, such as requests for predictions or classifications. For example, the model is exposed to provide a prediction of a security posture of a security policy configuration, such as a prediction of whether a particular device on the network is vulnerable to common exploits and vulnerabilities, or whether a particular device is exposed to an application, service, or other device.

At 1125, a determination is made as to whether process 1100 is complete. In some embodiments, process 1100 is determined to be complete in response to a determination that no further models are to be determined/trained (e.g., no further classification models are to be created), no further models are to be retrained, no further security policy configurations are to be analyzed, an administrator indicates that process 1100 is to be paused or stopped, etc. In response to a determination that process 1100 is complete, process 1100 ends. In response to a determination that process 1100 is not complete, process 1100 returns to 1105.

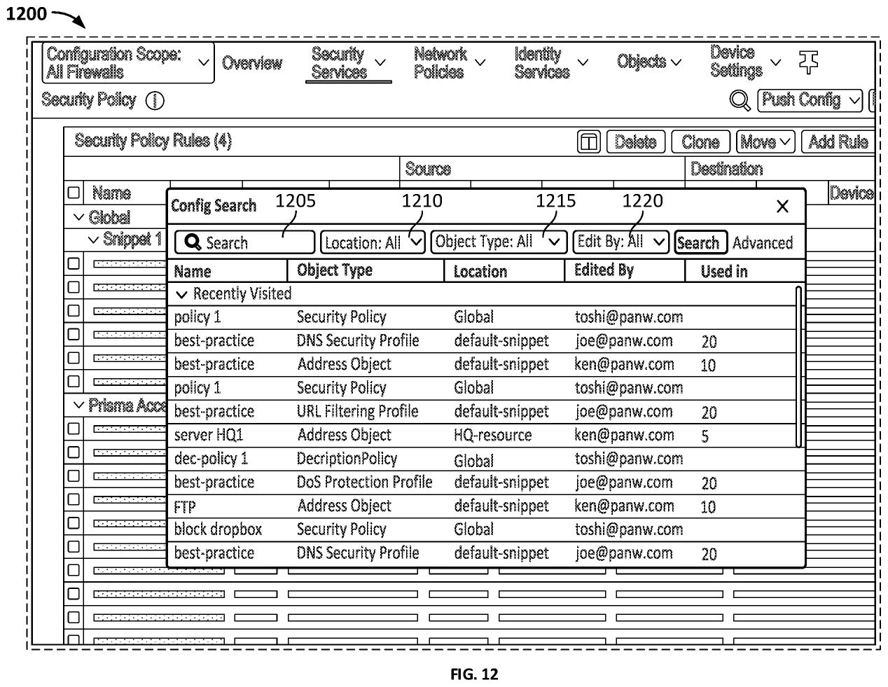

FIG. 12 is a user interface for querying a graph model according to various embodiments. In the example shown, user interface 1200 can be configured for, and provided to, a user to search a security policy configuration. The system configures user interface 1200 to enable the graph model to be queried. User interface 1200 may be used for performing basic queries against the security policy configuration.

As illustrated, user interface 1200 comprises field 1205 in which the user inputs a value to be searched (e.g., an object name, an object type, an UUID, an address, etc.). User interface further comprises one or more predefined fields 1210, 1215, and 1220 which can be drop down menus with predefined values for filtering the search. In the example shown, field 1210 comprises a filter for a location attribute, field 1215 corresponds to a filter for an object type, and field 1220 corresponds to a filter for an indication of an entity/user that edited the data object.

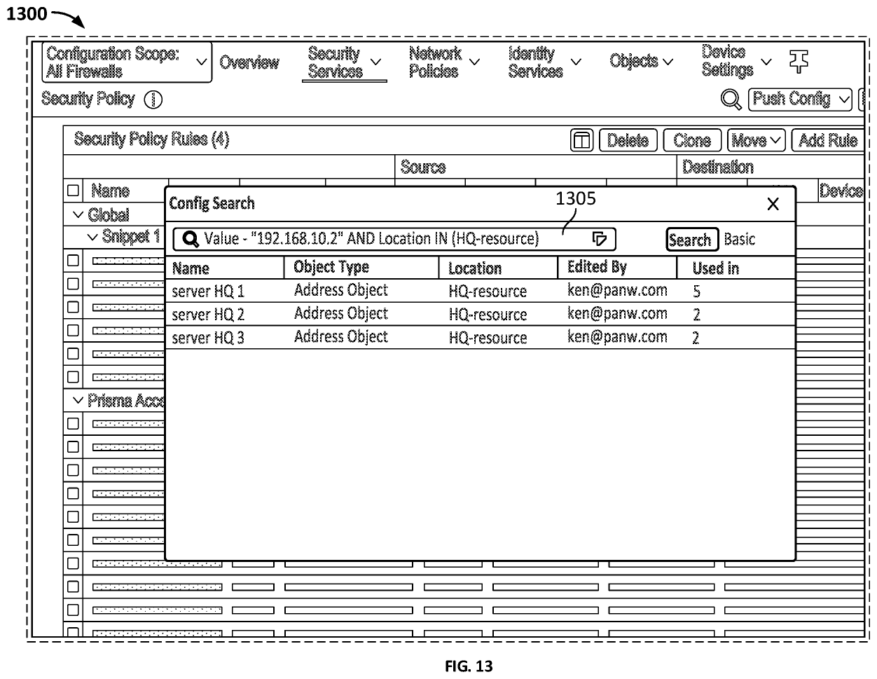

FIG. 13 is a user interface for querying a graph model according to various embodiments. In the example shown, user interface 1300 can be configured for, and provided to, a user to search a security policy configuration. The system configures user interface 1300 to enable the graph model to be queried. User interface 1300 may be used for performing advanced queries against the security policy configuration.

As illustrated, user interface 1300 comprises field 1305 in which the user inputs a value to be searched (e.g., a string comprising logic for filtering the security policy configurations, such as an IP address, an indication of a location, and indication of an object type, an indication of an object name, etc.).

Various examples of embodiments described herein are described in connection with flow diagrams. Although the examples may include certain steps performed in a particular order, according to various embodiments, various steps may be performed in various orders and/or various steps may be combined into a single step or in parallel.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A system, comprising:
one or more processors configured to:
generate a graph model using a model generator for a security policy configuration that includes a plurality of network parameters; and
process a query and generate a response using the graph model; and
a memory coupled to the one or more processors and configured to provide the one or more processors with instructions.

2. The system of claim 1, wherein the security policy configuration is a policy configuration for an enterprise network.

3. The system of claim 1, wherein the graph model comprises a labeled graph that includes nodes and edges.

4. The system of claim 1, wherein the one or more processors are further configured to:
determine, based at least in part on the graph model, an anomaly in the security policy configuration.

5. The system of claim 4, wherein the anomaly is an error, hole, or vulnerability in the security policy configuration.

6. The system of claim 1, wherein an application accesses the graph model via an application programming interface (API).

7. The system of claim 1, wherein a unique path edge of the graph model corresponds to an indirect relationship between the security policy configuration and a configured network parameter configured to avoid a vulnerability in the security policy configuration.

8. The system of claim 1, wherein the one or more processors are further configured to:
query the graph model to determine patterns in the security policy configuration.

9. The system of claim 8, wherein a predictive engine queries the graph model in connection with predicting patterns or vulnerabilities in the security policy configuration.

10. The system of claim 1, wherein the graph model is used in connection with a query for determining whether security policy configuration of an enterprise is vulnerable to common vulnerabilities and exposures (CVEs).

11. The system of claim 1, wherein the one or more processors are further configured to:
receive a search query; and
generate, based at least in part on the graph model, a response to the search query.

12. The system of claim 11, wherein:
the search query corresponds to a query for information pertaining to a particular IP address, and
generating the response to the search query comprises searching the graph model and returning a set of nodes associated with the particular IP address.

13. The system of claim 1, wherein a role-based security policy is configured based at least in part on the graph model.

14. The system of claim 1, wherein the one or more processors are further configured to train a machine learning model based at least in part on the graph model.

15. The system of claim 1, wherein a node in the graph model corresponds to a particular object class.

16. The system of claim 1, wherein the security policy configuration comprises a firewall policy.

17. The system of claim 1, wherein the security policy configuration comprises a virtual private network (VPN) policy.

18. The system of claim 1, wherein the security policy configuration comprises a cloud security policy.

19. The system of claim 1, wherein the graph model is stored in a graph database.

20. The system of claim 1, wherein the graph model is generated based at least in part on a predefined graph data model template.

21. The system of claim 1, wherein the graph model comprises nodes for over ten hundred thousand devices.

22. A method, comprising:
generating a graph model using a model generator for a security policy configuration that includes a plurality of network parameters; and
processing a query and generating a response using the graph model.

23. A computer program product embodied in a non-transitory computer readable medium, and the computer program product comprising computer instructions for:
generating a graph model using a model generator for a security policy configuration that includes a plurality of network parameters; and
processing a query and generating a response using the graph model.
